(19) United States
(12) Patent Application Publication
(10) Pub. No.: US 2006/0020751 A1
(43) Pub. Date: Jan. 26, 2006

(54) Medium storage device, cache segment switching method for medium storage device, and medium storage system

(75) Inventors: Masahiro Ito, Higashine (JP); Kenichi Suto, Higashine (JP); Kenji Yoneki, Higashine (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 11/006,092

(22) Filed: Dec. 7, 2004

(30) Foreign Application Priority Data
Jul. 23, 2004 (JP) 2004-216118

(51) Int. Cl. G06F 12/00

(52) U.S. Cl. 711/113

(57) ABSTRACT

A medium storage device switches the number of segments of a cache memory according to the transfer volume from a host, and this medium storage device switches the number of segments at high-speed. The medium storage device changes the number of segments of the cache memory according to the maximum transfer volume of one command depending on the type of the OS, based on the notification from the host device on the type of the OS. By this, the medium storage device executes write processing at high-speed using the number of segments appropriate for the write processing of the OS.

### CROSS-REFERENCE TO RELATED APPLICATIONS

This application is based upon and claims the benefit of priority from the prior Japanese Patent Application No. 2004-216118, filed on Jul. 23, 2004, the entire contents of which are incorporated herein by reference.

### BACKGROUND OF THE INVENTION

1. Field of the Invention

The present invention relates to a medium storage device having a cache memory, cache segment switching method for the medium storage device, and a medium storage system, and more particularly to a medium storage device for dynamically changing the number of divided segments of a cache memory, cache segment switching method for the medium storage device, and a medium storage system.

2. Description of the Related Art

With the recent improvement in access speeds, a cache memory for temporarily storing write data from a host and read data from a medium is installed on a medium storage device, such as a magnetic disk device, optical disk device and magneto-optical disk device. By this cache memory, when data is written, the write data from the host can be stored in the cache memory and be written later to a medium (called a write back), which can improve the medium write speed. When the data is read, the data, as well as the data near the accessed data, are read from the medium and stored in the cache memory, so that if the target data exists in the cache memory at the next read/write access, the data in the cache memory can be transferred to the host or the data in the cache memory can be updated, therefore the response speed can be improved.

In such a cache memory, a large volume of data can be stored, so it is effective for searching the target data to divide the cache memory area into a plurality of segments. Since the capacity of one segment is predetermined, fixing the number of divided segments makes effective use of the cache memory difficult, because the transfer volume requested from the host device is variable. Also in the case of a medium storage device which reads or writes data in segment units, the number of times of read/write increases, and sufficient performance cannot be implemented.

Therefore various methods for dynamically changing the number of segments according to the transfer volume from the host device have been proposed. The first conventional method is providing a function, to learn the transfer data volume and the access type of a read/write (single or sequential), to the medium storage device, and change the number of divided segments if the number of divided segments is not appropriate for the transfer data volume and access type (e.g. Japanese Patent Application Laid-Open No. H 7-319771).

The second conventional method is changing the number of divided segments depending on the type of logical format of the medium (e.g. cluster size) (e.g. Japanese Patent Application Laid-Open No. 2000-227865).

### SUMMARY OF THE INVENTION

The first conventional method, however, changes the number of divided segments based on the history of the predetermined number of times of data transfer volume and access type, which is recorded in advance, so the number of segments is not changed until learning completes. Therefore it is difficult to set an optimum number of segments quickly in a respective environment. In other words, the problem is that the high speed of a medium storage device cannot be expressed until learning completes.

The second convention method, on the other hand, depends only on the format of the medium, so the various command sequences of an OS (Operating System) of a host device cannot be adapted to, and the effect of segment separation may not be expected if the command sequence of an OS changes.

With the foregoing in view, it is an object of the present invention to provide a medium storage device, a cache segment switching method for the medium storage device, and a medium storage system for dividing into an optimum number of segments at high-speed even if the command sequence of an OS is different, and improving the speed of processing by the cache memory.

It is another object of the present invention to provide a medium storage device, a cache segment switching method for the medium storage device, and a medium storage system for dividing into an optimum number of segments at high-speed even if the device is connected to various OSs, and improving the speed of processing by the cache memory.

It is still another object of the present invention to provide a medium storage device, a cache segment switching method for the medium storage device, and a medium storage system for dividing into an optimum number of segments at high-speed according to the maximum transfer volume of an OS, and improving the speed of processing by the cache memory.

It is still another object of the present invention to provide a medium storage device, a cache segment switching method for the medium storage device, and a medium storage system for adding a high-speed division function to optimize the number of segments for a USB device, which enables connection to various OSs.

To achieve these objects, a medium storage device of the present invention is a medium storage device connected to a host device for storing write data from the host device, having a medium drive unit for recording data to a medium, a cache memory for storing the write data from the host device, and a controller for managing the number of segments of the cache memory and recording the write data stored in the cache memory to the medium drive unit. And the controller sets the number of segments of the cache memory according to the type of OS of the host device notified from the host device in advance before the transfer of the write data.

A cache segment switching method of the present invention is a cache segment switching method for a medium storage device connected to a host device for storing write data from the host device, having the steps of setting the number of segments of a cache memory according to the type of OS of the host device notified from the host device in advance before the transfer of the write data, storing the write data from the host device in the segment units of the cache memory that were set, and receiving the write data stored in the cache memory to the medium drive unit.

A medium storage system of the present invention is a medium storage system having a host device for issuing a write command and write data, and a medium storage device connected to the host device for storing the write data from the host device. And the medium storage device has a medium drive unit for recording data to a medium, a cache memory for storing the write data from the host device, and a controller for managing the number of segments of the cache memory and recording the write data stored in the cache memory to the medium drive unit. And the host device notifies the type of OS of the host device to the medium storage device by the driver in advance before the transfer of the write data, and the controller sets the number of segments of the cache memory according to the type of OS.

In the present invention, it is preferable that the controller sets the number of segments of the cache memory according to the type of OS of the host device notified in CDB (Control Data Block) format from the host device in advance before the transfer of the write data.

In the present invention, it is also preferable that the controller sets the number of segments of the cache memory according to the type of OS of the host device and the type of format notified from the host device in advance before the transfer of the write data.

In the present invention, it is also preferable that the controller has a table for storing the number of segments of the cache memory according to the type of the OS of the host device sent from the host device, and sets the number of segments of the cache memory by referring to the table.

In the present invention, it is also preferable that the controller sets the number of segments of the cache memory according to the type of the OS of the host device that is set in a write command notified in CDB format from the host device in advance before the transfer of the write data.

In the present invention, it is also preferable that the controller sets the number of segments of the cache memory according to the type of the OS of the host device that is set in a vendor command notified in CDB format from the host device in advance before the transfer of the write data.

In the present invention, it is also preferable that the controller executes a write operation of the medium drive unit in the segment units of the cache memory.

In the present invention, it is also preferable that the medium drive unit is structured by a drive mechanism for writing to the medium by a head.

According to the present invention, the number of segments of the cache memory is changed according to the maximum transfer volume of one command, which depends on the type of the OS, based on notification from the host device, so write processing can be executed at high-speed with the number of segments appropriate for the write processing of the OS.

### DESCRIPTION OF THE DRAWINGS

FIG. 1 is a block diagram depicting a medium storage system according to an embodiment of the present invention;

FIG. 2 is a block diagram depicting the medium storage device of FIG. 1;

FIG. 3 shows the configuration of the segment division table in FIG. 2;

FIG. 4 shows the configuration of the segment management table in FIG. 2;

FIG. 5 shows the relationship between the OS type, format type and segment capacity in FIG. 3;

FIG. 6 shows the CDB (Control Data Block) according to the first embodiment of the present invention;

FIG. 7 shows a sequence of the segment count control according to the first embodiment of the present invention;

FIG. 8 is a flow chart depicting a processing in FIG. 7;

FIG. 9 is a diagram depicting the operation in FIG. 8;

FIG. 10 is a flow chart depicting another processing in FIG. 7;

FIG. 11 is a diagram depicting the operation in FIG. 10;

FIGS. 12 (A) and 12 (B) are diagrams depicting the drive operation of the present invention;

FIG. 13 shows the CDB (Control Data Block) of a vendor command according to the second embodiment of the present invention;

FIG. 14 shows the CDB of a write command according to the second embodiment of the present invention;

FIG. 15 shows a sequence of the segment count control of the second embodiment of the present invention;

FIG. 16 is a flow chart depicting a processing in FIG. 15; and

FIG. 17 is a diagram depicting the operations in FIG. 15 and FIG. 16.

### DESCRIPTION OF THE PREFERRED EMBODIMENTS

Embodiments of the present invention will now be described in the sequence of the medium storage system, first embodiment, second embodiment and other embodiments.

Medium Storage System

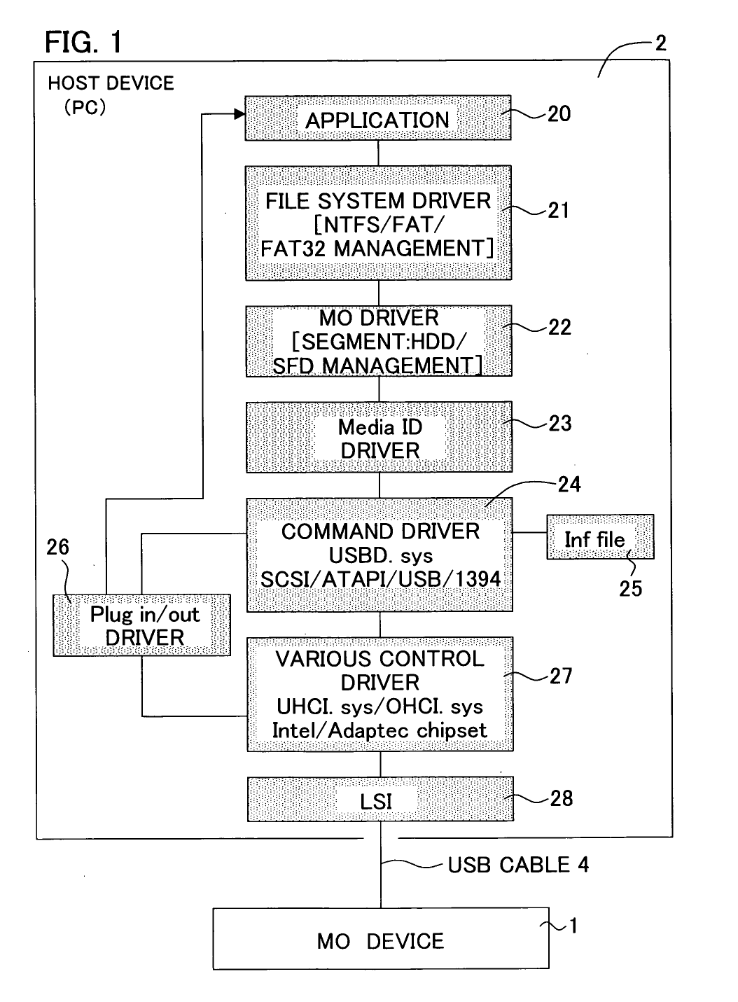

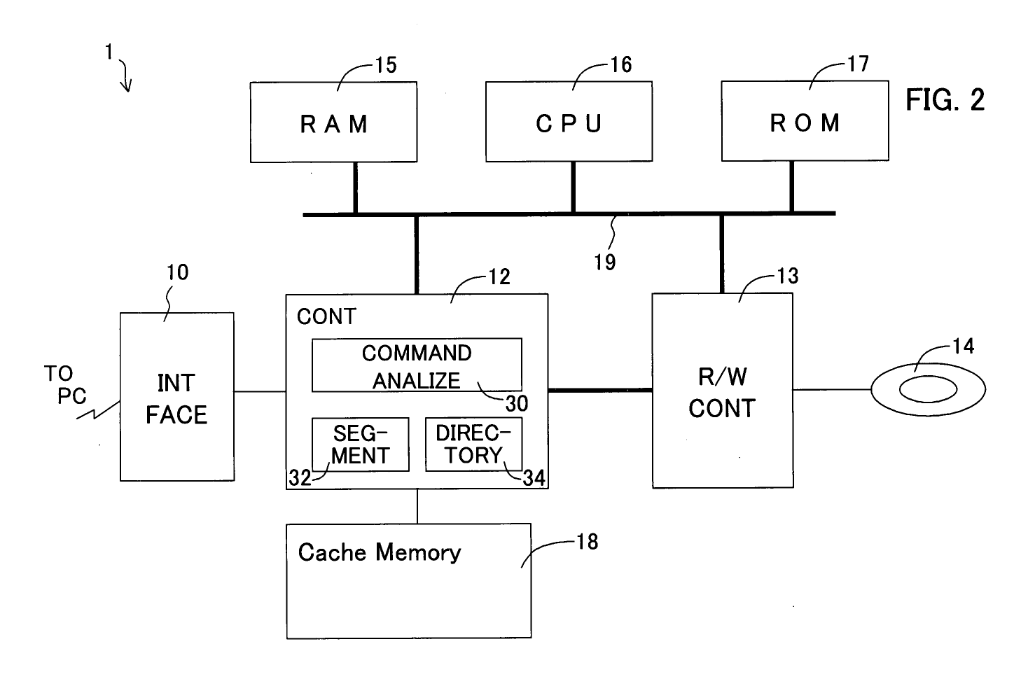

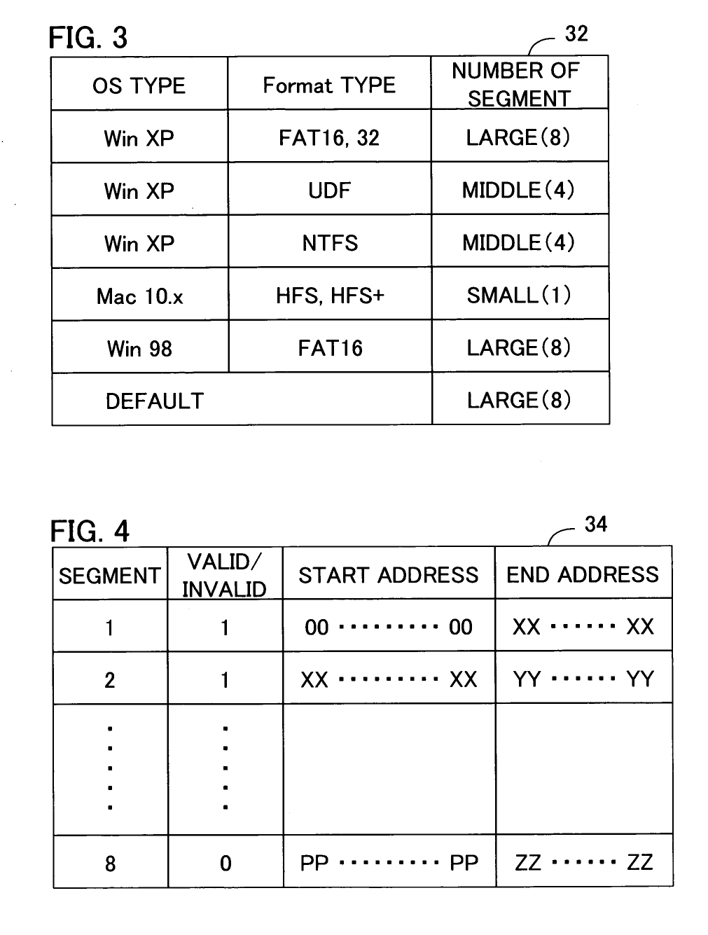

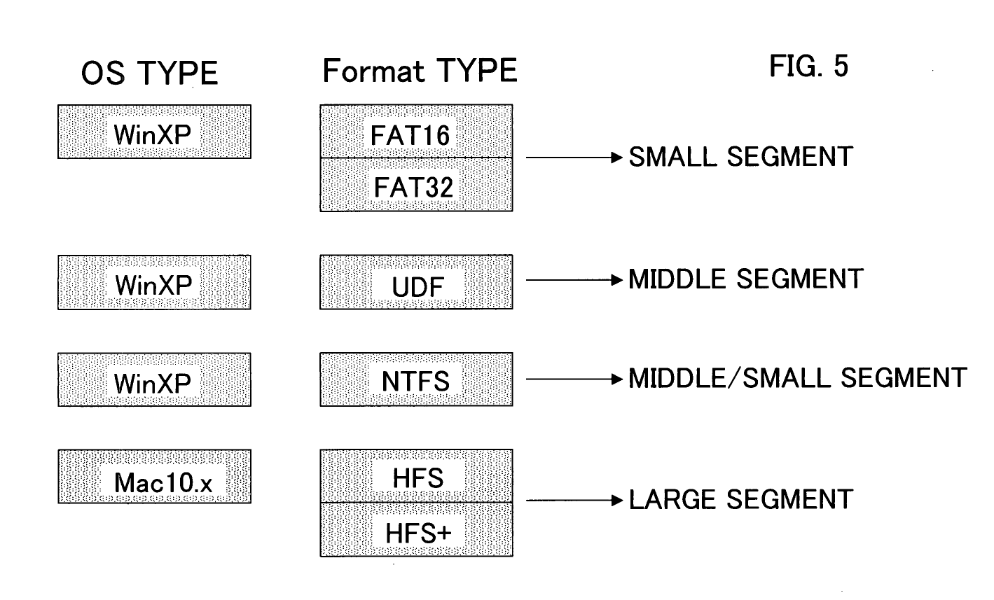

FIG. 1 is a block diagram depicting the medium storage system according to an embodiment of the present invention, FIG. 2 is a block diagram depicting the medium storage device in FIG. 1, FIG. 3 shows the configuration of the segment division table in FIG. 2, FIG. 4 shows the configuration of the segment management table of the cache memory, and FIG. 5 shows an example of segment division by the OS according to the present invention. FIG. 1 to FIG. 5 show a magneto-optical disk device as the medium storage device.

As FIG. 1 shows, the medium storage device (magneto-optical disk device: MO drive) 1 is connected to the host device 2, such as a personal computer (PC), by the USB cable 4.

As a program configuration, the host device 2 has an application 20, such as Word (Microsoft trademark), a file system driver 21 for managing a file system, such as NTFS (NT File System)/FAT (File Allocation Table)/FAT 2, an MO (device) driver 22 for managing the format of cache segments, the HDD (Hard Disk Device) type and SFD (Super Flexible Disk) type, a medium ID driver 23, a command driver 24 for managing the command format, such as SCSI (Small Computer Serial Interface)/ATAPI (AT Attached Parallel Interface)/USB (Universal Serial Bus), an information file 25 for storing the setup information in the case of a USB, and a plug in/out driver 26 for detecting plug in/out. As hardware, the host device 2 has a driver circuit 27 for various controllers (chip set), and an LSI circuit for interface 28.

The MO device 1, on the other hand, has an interface circuit 10 for connecting with the host device 2, a disk controller 12, a read/write controller 13, a disk drive 14, a CPU (processor) 16 for controlling the operation of the disk drive 14, a RAM (Random Access Memory) 15 for processing of the CPU 16, a ROM (Read Only Memory) 17 for storing the processing programs of the CPU 16, a cache memory (also called a buffer memory) 18 and a bus 19 for connecting the CPU 16, RAM 15, ROM 17, disk controller 12 and read/write controller 13, as shown in FIG. 2.

The disk drive 14 is constructed of a known MO drive, and has a spindle motor for rotating the MO disk, an optical head for reading/writing data to/from the MO disk, and an actuator for moving the optical head to a desired track position of the MO disk.

The R/W controller 13 has a data format control circuit, read amplifier, binary circuit, write driver, actuator driver, focus/track servo control circuit of the optical head, and control circuits thereof. The disk controller 12 has a command analysis unit 30 for analyzing commands from the host device 2 and the CPU 1, a segment division table 32, which will be described in FIG. 3, and a segment management (directory) table 34 for managing the segments of the cache memory 18, which will be described in FIG. 4.

In the cache memory 18, the segments are managed by the segment management table 34, and the write data and read data are stored in the segment unit. The cache memory 18 is constructed by a memory having a 2 Mbyte capacity, for example, and if the number of segments is “8”, then the capacity of one segment is 250 Kbytes, and if the number of segments is “16”, then the capacity of one segment is 125 Kbytes.

The CPU 16 receives an analyzed command from the disk controller 12, controls the read/write controller 13 according to the command, sets the disk drive 14 to the read/write enabled status for a track according to the command, and returns a reply to the disk controller 12.

When reading, the disk controller 12 refers to the cache memory 18, and transfers the read data from the cache memory 18 to the host device 2 if the requested data exists, and if not, the disk controller 12 receives the read data from the R/W controller 13, stores it to the cache memory 18, and then transfers it to the host device 2. When writing, the disk controller 12 stores the write data from the host device 2 to the cache memory 18, then writes it back to the disk of the disk drive 14 via the R/W controller 13.

The segment division table 32 will be described with reference to FIG. 3 and FIG. 5. As FIG. 5 shows, in the case of a Windows (registered trademark) OS, the maximum volume to be transferred by one command is limited to 32 Kbytes (0×80 blocks (×512 bytes)). In the case of a Mac (registered trademark) OS, on the other hand, 500 Mbytes of one file (=1000 blocks (×512 bytes)/sector)) can be copied by a drag & drop operation. In this way, the maximum transfer volume is different depending on the OS.

The present invention is primarily for performing segment division that is optimum for the type of the OS, focusing on the maximum transfer volume of the OS. In other words, the type of the OS is notified from the OS to the MO device, and the MO device performs segment division which is appropriate for the maximum transfer volume of the OS.

In some cases, the number of divided segments may be changed depending on the type of the file format. For example, in the case of the Windows (registered trademark) OS, FAT (File Allocation Table) 16 and 32, UDF (Universal Disk Format) and NTFS (NT File System) etc. are used.

FAT 16 and 32 are mainly recording formats of an HDD in cluster units, and manages the operating conditions of the clusters. FAT 16 is for a cluster length of 32 Kbytes, and FAT 32 is for a cluster length of 4 Kbytes.

The UDF is a format of a magneto-optical disk device, of which the maximum transfer volume is different. NTFS is a file system of Windows NT, and supports file compression. The maximum transfer volume differs depending on the file format.

In the Mac OS, HFS (Hierarchical File System) is used. For example, as FIG. 3 and FIG. 5 show, in the case of Windows XP, small segments (number of segments is large) are used for FAT 16/32, medium segments (number of segment is medium) are used for UDF, medium segments (number of segments is medium) are used for NTFS, and in the case of Mac 10.x, large segments (number of segments is small) are used.

The number of segments, according to the type of OS and format, are stored in the segment division table 32 in FIG. 3, and the large number of segments is stored as the initial value (default). In this example, the examples of the number of segments is “8”, “4” and “1”, but is not limited to these numbers.

As FIG. 4 shows, the segment management table 34 stores the valid/invalid (link) of each segment, and the start address and the end address of the cache memory 18. The disk controller 12 refers to the segment division table 32, and updates the segment management table 34 according to the determined number of segments.

### First Embodiment

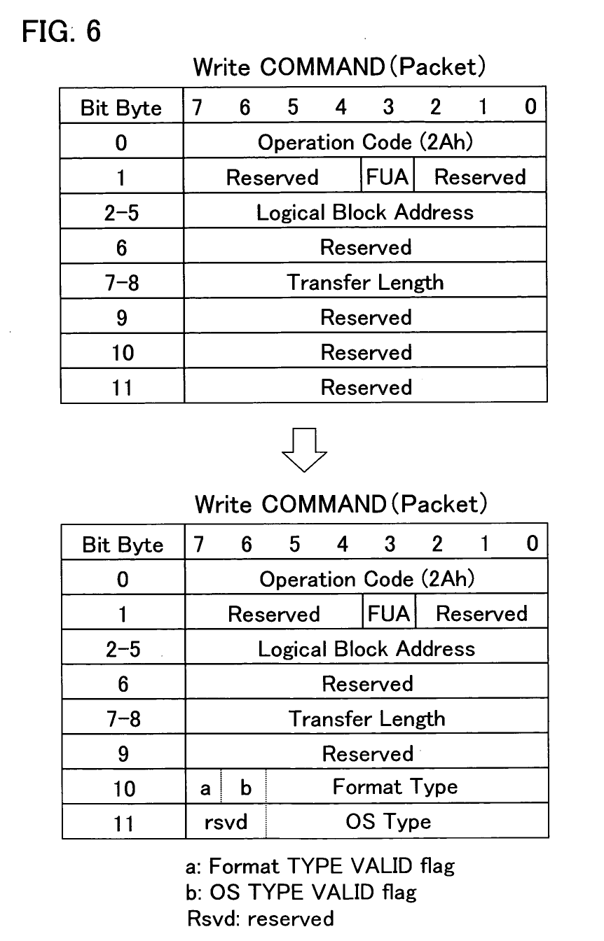

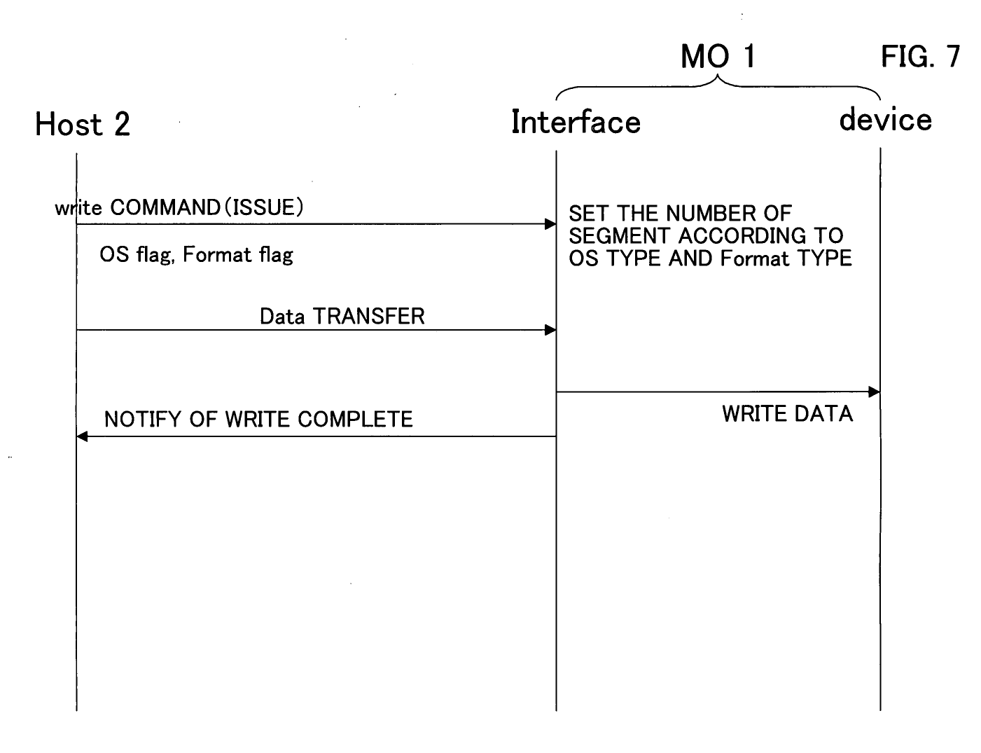

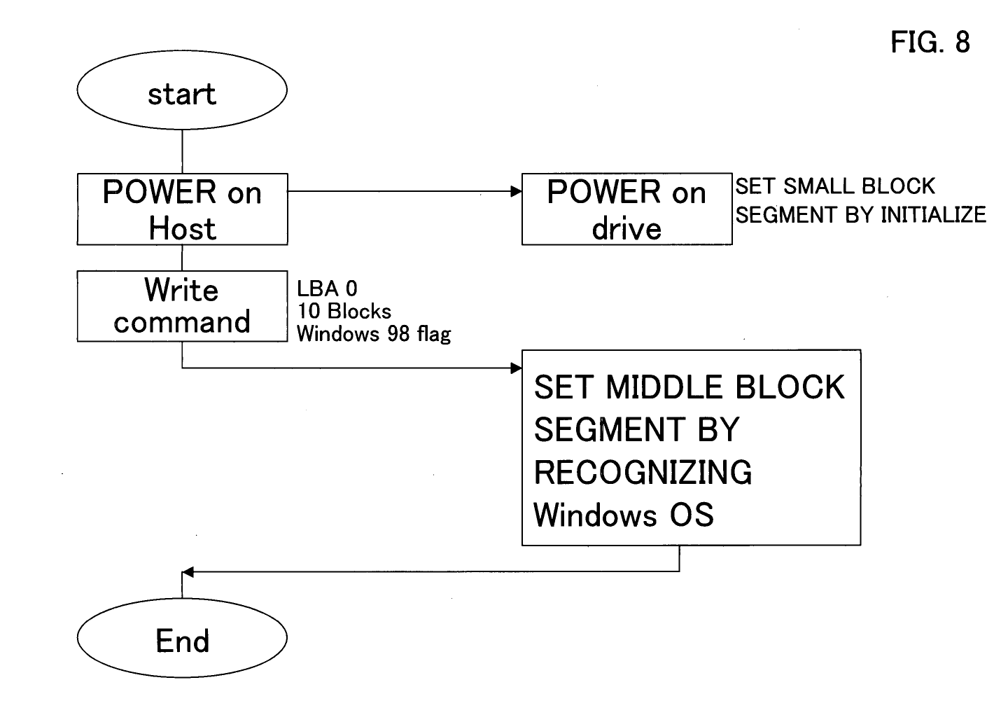

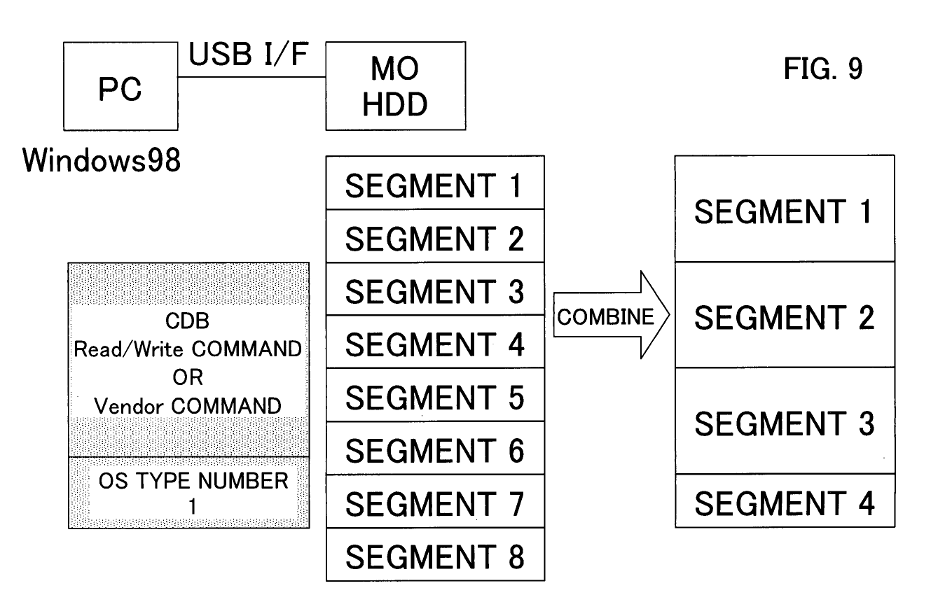

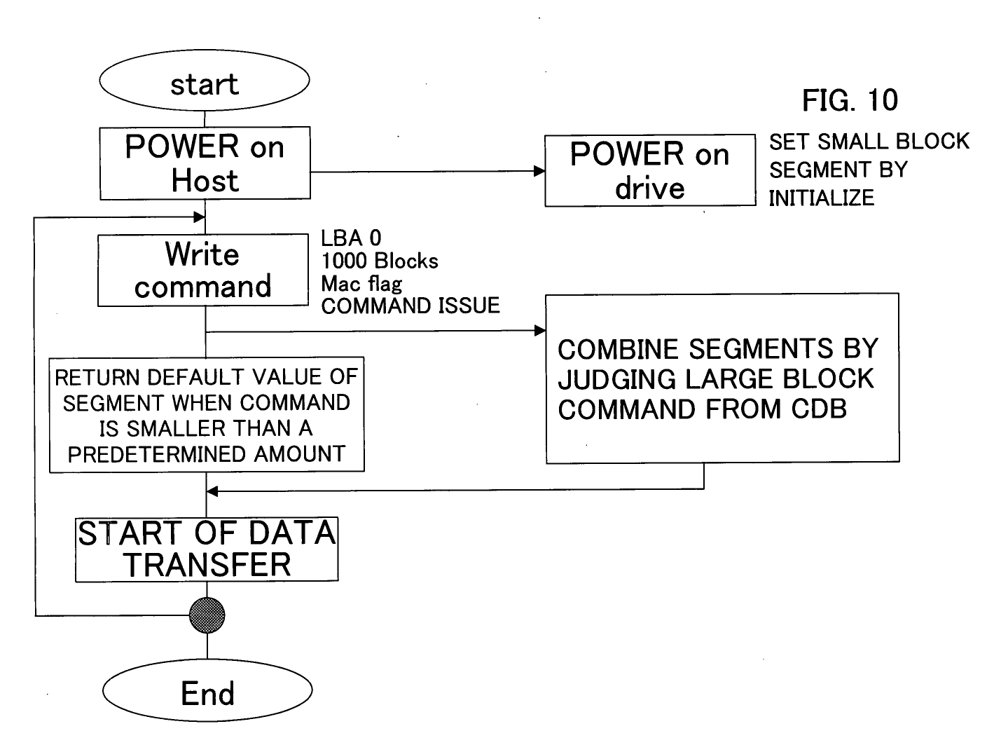

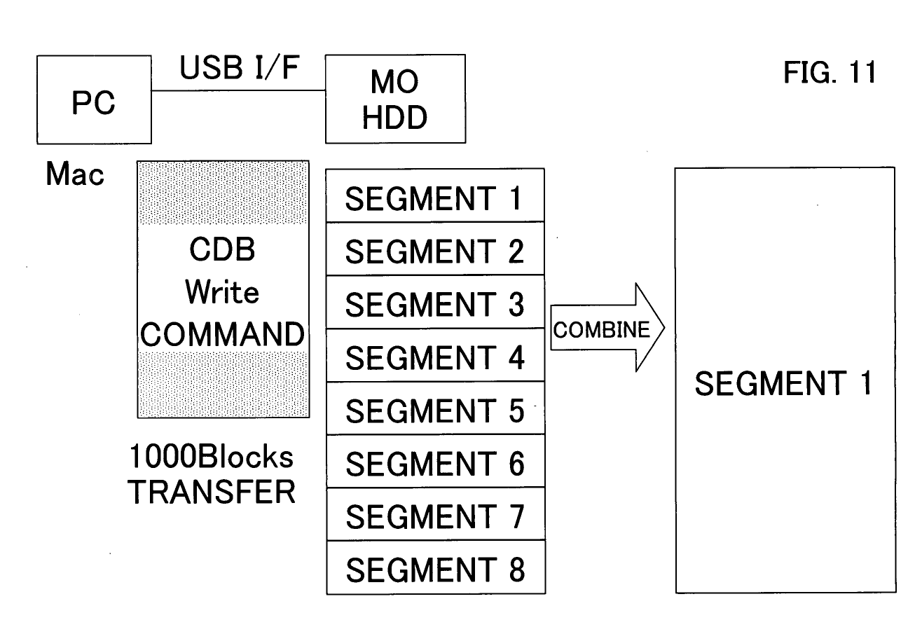

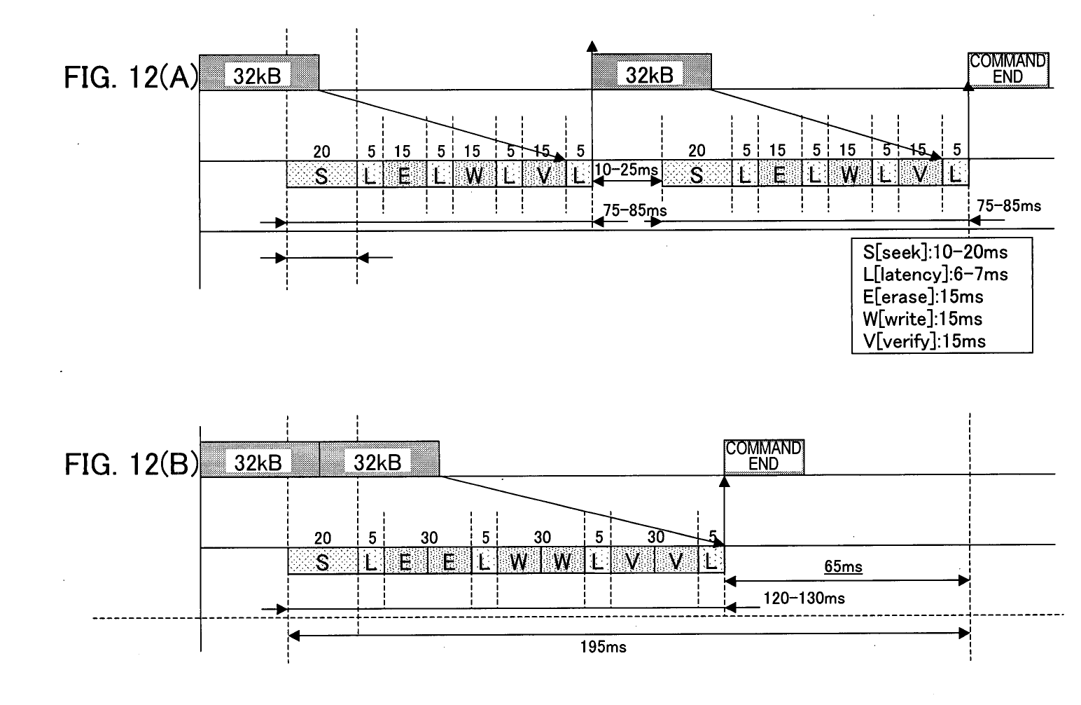

FIG. 6 shows the CDB (Control Data Block) according to the first embodiment of the present invention, FIG. 7 shows the sequence of the segment count control according to the first embodiment of the present invention, FIG. 8 and FIG. 9 are flow charts depicting the processing in FIG. 7, FIG. 10 and FIG. 11 are diagrams depicting the operations in FIG. 7 to FIG. 9, and FIGS. 12 (A) and 12 (B) are diagrams of the drive operation according to the present invention.

As FIG. 6 shows, the packet (CDB) issued from the host 1 consists of 12 bytes, where byte ‘0’ is an operation code (e.g. write/read), 2^{nd}-5^{th} bytes are a logical block address, 7^{th}-8^{th} bytes are a transfer length, and remainder of bytes are reserved, which the vendor and user can use freely.

In the present invention, the OS type and the format type are set in the reserve bytes of the CDB. For example, as the bottom of FIG. 6 shows, the valid flag ‘a’ of the format type, the valid flag ‘b’ of the OS type and the format type are written to the 10^{th} byte when a write command is issued in the CDB. The OS type is written to the 11^{th} byte.

Now the host and the write processing, including the number of the segment change sequence, will be described with reference to FIG. 7 and FIG. 8. As FIG. 7 shows, the host device 2 issues a write command in the CDB shown in FIG. 6. At this time, as FIG. 6 shows, the valid flag ‘a’ of the format type, the valid flag ‘b’ of the OS type and the format type (called the format flag) are written to the 10^{th} byte of the CDB, and the OS type (called the OS flag) is written to the 11^{th} byte. For the creation of the CDB, including this writing, the MO driver 22 in FIG. 1 recognizes the file system driver 21 and notifies it to the command driver 24 by segment management, and the command driver 24 executes it.

The MO device 1 sets the number of segments depending on the OS type and the format type in the CDB. As FIG. 8 shows, the MO device 1 creates the segment management table 34 using a small block (number of segments is high), which is the default value by initialization when power ON (current in the case of USB), is received from the host. And when the write command is received from the host, the command analysis unit 30 of the disk controller 12 of the MO device 1 executes the number of the segment change processing.

In the examples of FIG. 8 and FIG. 9, the controller 12 of the MO device 1 recognizes that the OS is Windows 98 by the OS flag, and determines an intermediate block (number of segment is medium, “4”) referring to the table 32 in FIG. 3. And the controller 12 updates the segment management table 34 according to the determined number of segments. FIG. 9 shows the divided segments of the cache memory 18.

In the examples of FIG. 10 and FIG. 11, the controller 12 of the MO device 1 recognizes that the OS is Mac by the OS flag, and determines a large block (number of segments is small, “1”) referring to the table 32 in FIG. 3. And the controller 12 updates the segment management table 34 according to the determined number of segments. FIG. 11 shows the divided segments of the cache memory 18.

Referring back to FIG. 7, when a write data is transferred from the host device 2, the disk controller 12 of the MO device 1 stores the write data in segment units of the cache memory 18 determined in the segment management table 34, then the disk controller 12 sends the write data in the cache memory 18 to the drive 14 in segment units, and writes it to the medium (MO disk). And notifies the completion of writing to the host device 2.

FIG. 12 (A) and FIG. 12 (B) are diagrams depicting the write operation of the disk device. FIG. 12 (A) is a diagram depicting the operation of the MO drive when one segment is 32 Kbytes, and FIG. 12 (B) is a diagram depicting the operation of the MO drive when one segment is 64 Kbytes.

As FIG. 12 (A) and FIG. 12 (B) show, when data is input to the write buffer (cache memory 18), the MO device 1 performs seek operation (S), positions the optical head on the specified track, and executes erase (E), write (W) or verify (V) of the specified sector (singular or plural). L (Latency) is the wait time for rotation, for example.

Therefore when a write data exceeding 32 Kbytes is received by one command, the sequence of seek, erase, write and verify is executed twice when one segment is set to 32 Kbytes, as shown in FIG. 12 (A). If one segment is set to 64 bytes, as shown in FIG. 12 (B), the sequence of seek, erase, write and verify is executed only once.

Therefore when one segment is 64 Kbytes, as shown in FIG. 12 (B), the time required until completion of the write command can be about ⅔ (130/195 ms) compared with the case when one segment is 32 Kbytes in FIG. 12 (A), thereby the over head time can be decreased. Particularly when the maximum transfer volume is 600 Mbytes, as in the case of the Mac OS, this feature is even more effective.

When the maximum transfer volume by one command is 32 Kbytes, as in the case of the Windows OS, on the other hand, it is preferable in terms of effect to use the cache memory 18 where one segment is 32 bytes, as shown in FIG. 12 (A).

When the OS flag and the format flag in CDB do not indicate valid, as shown in FIG. 10, the number of segments is returned to the initial value. In the case of the example in FIG. 10, for example, the number of segments is set to the maximum if the OS flag and the format flag in the CDB indicate valid, as shown in FIG. 11, so the number of segments of the cache memory 18 becomes “1”, and since no other write data exists after this write command completes, it is no problem to change the number of segments for the next write command.

In this way, by changing the number of segments of the cache memory 18 according to the maximum transfer volume by one command, which depends on the OS, based on notification from the OS, write processing can be performed at high-speed with the number of segments appropriate for the write processing of this OS. Also as FIG. 5 shows, even if the OS is the same, the maximum transfer volume by one command may differ depending on the format type of the file system, so it is even more effective if the number of segments is changed according to the OS type and the format type.

Also notification from the OS is in CDB format, so the write processing can be executed simply without changing the command format. This information is set in the write command, so it can be implemented without changing the number of commands issued from the OS side.

Particularly in the case of an optical disk in the medium storage device, the MO drive executes erase/write/write verify when writing, as shown in FIG. 12, and an MD (Mini Disk) drive and DVD drive executes overwrite/verify read, which is also the same for an HDD drive. Until this verify read ends, the data of the cache memory must be saved for the case of a failure in writing, so by changing the number of segments to optimize the receive volume from the host device, which depends on the OS, the transfer wait time of the host device is decreased, and a high-speed response to write processing for the host device can be implemented.

### Second Embodiment

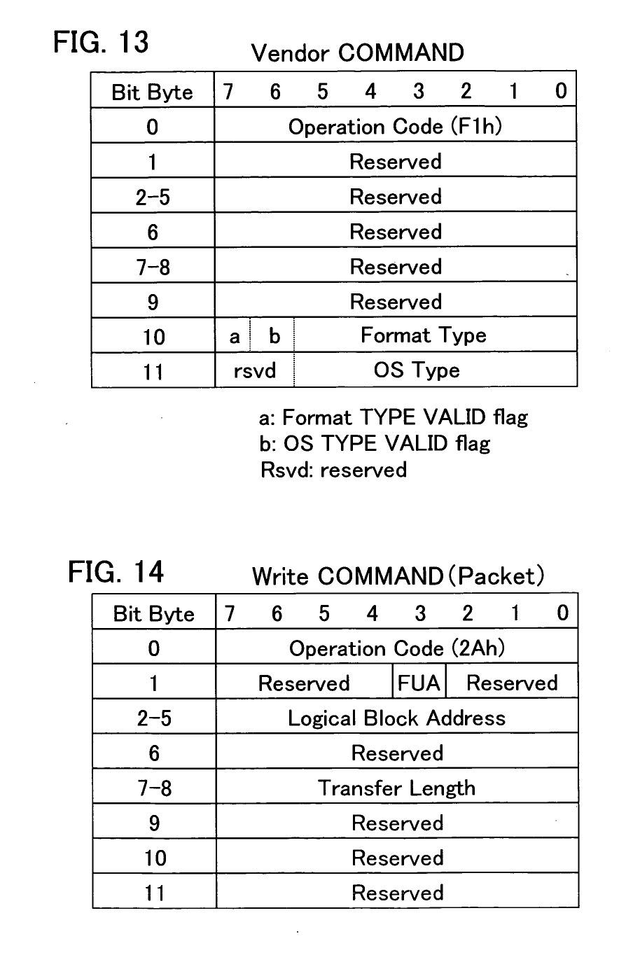

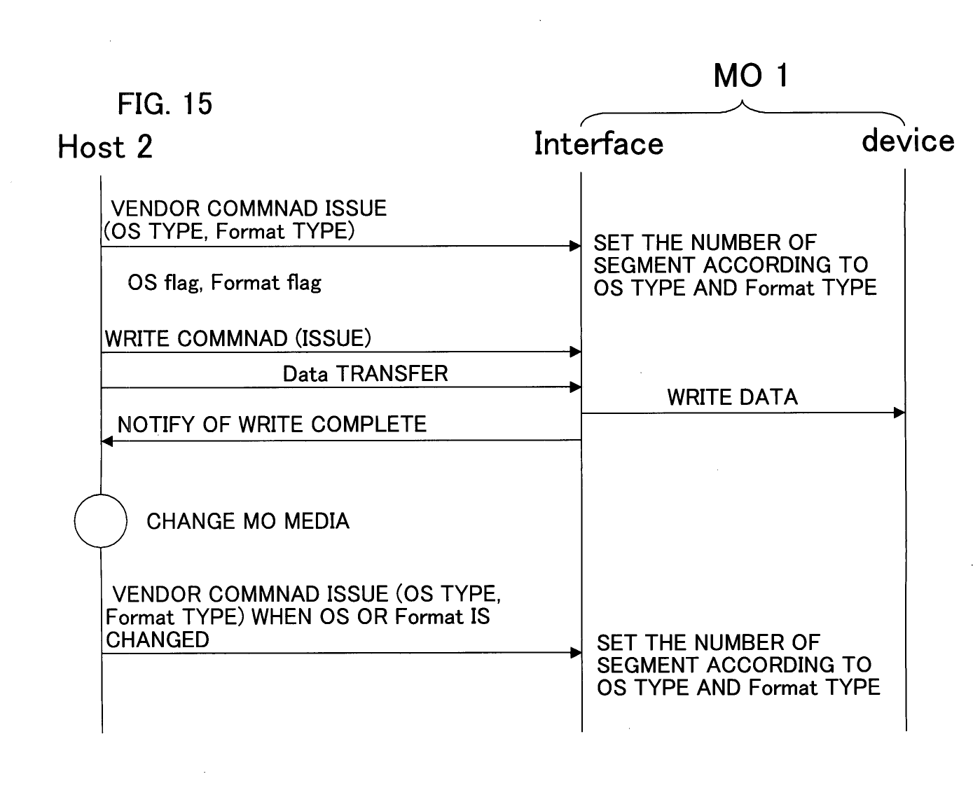

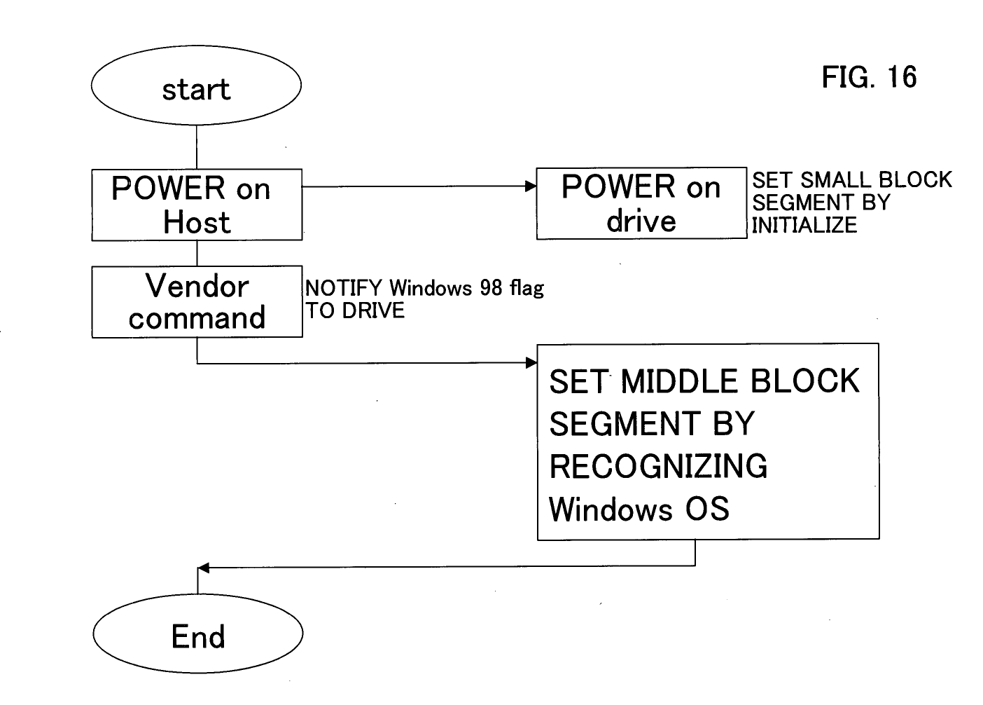

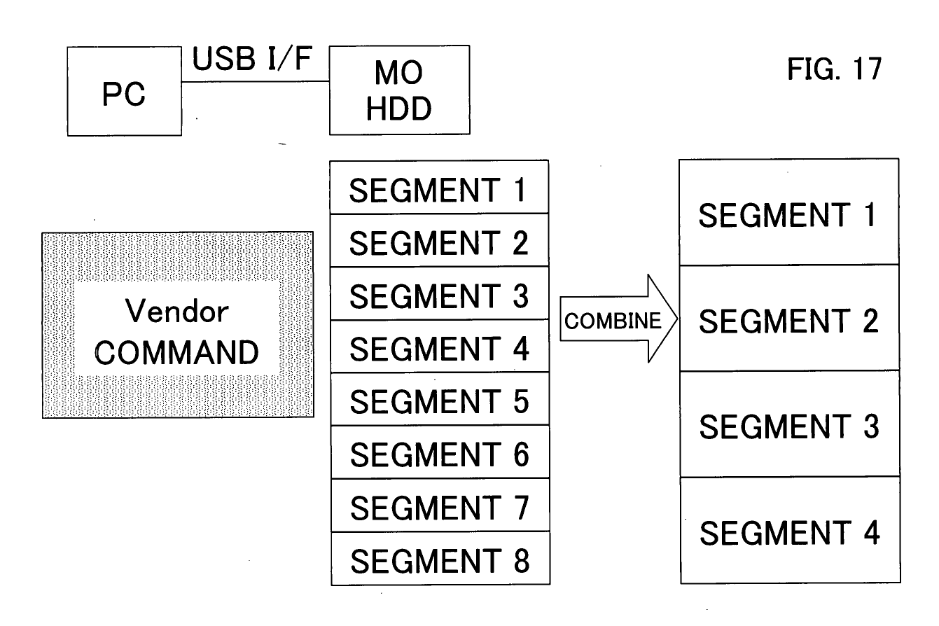

FIG. 13 shows the CDB (Control Data Block) of the vendor command according to the second embodiment of the present invention, FIG. 14 shows the CDB of the write command according to the second embodiment of the present invention, FIG. 15 shows the sequence of the number of the segment control according to the second embodiment of the present invention, FIG. 16 is a flow chart depicting the processing in FIG. 15, and FIG. 17 is a diagram depicting the operations in FIG. 15 and FIG. 16.

As FIG. 13 and FIG. 14 show, the packet (CDB) issued from the host consists of 12 bytes, where the byte ‘0’ is an operation code (e.g. write/read), 2^{nd}-5^{th} bytes are a logical block address, 7^{th}-8^{th} bytes are a transfer length, and the remainder of the bytes are reserved, which the vendor and user can use freely.

In this embodiment as well, the OS type and the format type are set in the reserve bytes of the CDB. As FIG. 13 shows, the vendor command is set by the CDB, where the vendor command (F1h) is set in the operation code, the 2^{nd}-9^{th} bytes are reserved, the valid flag ‘a’ of the format type and the valid flag ‘b’ of the OS type, and the format type are written in the 10^{th} byte. The OS type is written in the 11^{th} byte.

And in this embodiment, as FIG. 13 shows, this information is set in the CDB of the write command, where the 2^{nd}-5^{th} bytes are the logical address, the 7^{th}-8^{th} bytes are the transfer length, and the remainder is reserved.

Now the host and the write processing, including the number of the segment change sequence, will be described with reference to FIG. 15 and FIG. 16. As FIG. 15 shows, the host device 2 issues a vendor command in the CDB, shown in FIG. 13. At this time, as FIG. 13 shows, the valid flag ‘a’ of the format type, the valid flag ‘b’ of the OS type, and the format type (called a format flag) are written in the 10^{th} byte of the CDB, and the OS type (called the OS flag) is written in the 11^{th} byte. For the creation of the CDB including this writing, the MO driver 22 in FIG. 1 recognizes the file system driver 21, and notifies it to the command driver 24 by segment management, and the command driver 24 executes it.

The MO device 1 sets the number of segments depending on the OS type and the format type in the CDB. As FIG. 16 shows, the MO device 1 creates the segment management table 34 using a small block (number of segments is high), which is the default value by initialization when power ON (current in the case of USB), is received from the host. And when the vendor command is received from the host, the command analysis unit 30 of the disk controller 12 of the MO device 1 executes the number of the segment change processing.

In the examples of FIG. 15 and FIG. 16, the controller 12 of the MO device 1 recognizes that the OS is Windows 98 by the OS flag, and determines an intermediate block (number of segments is medium, “4”) referring to the table 32 in FIG. 3. And the controller 12 updates the segment management table 34 according to the determined number of segments. FIG. 16 shows the divided segments of the cache memory 18.

Referring back to FIG. 15, when a general write command (FIG. 14) and write data are transferred from the host device 2, the disk controller 12 of the MO device 1 stores the write data in segment units of the cache memory 18 determined in the segment management table 34, then the disk controller 12 sends the write data in the cache memory 18 to the drive 14 in segment units, and writes it to the medium (MO disk). And notifies the completion of writing to the host device 2.

In this way, by changing the number of segments of the cache memory 18 according to the maximum transfer volume by one command, which depends on the OS, based on notification from the OS, write processing can be performed at high-speed with the number of segments appropriate for the write processing of that OS. Also as FIG. 5 shows, even if the OS is the same, the maximum transfer volume by one command may differ depending on the format type of the file system, so it is even more effective if the number of segments is changed according to the OS type and the format type.

Also notification from the OS is in CDB format, so the write processing can be executed simply without changing the command format. Since the vendor command is used, this information can be changed by the setting by the vendor without changing the command system recognized by the OS side.

### Other Embodiments

In the above embodiments, the medium storage device was described using a magneto-optical disk device, but the present invention can also be applied to other medium storage devices, such as a magnetic disk device and an optical disk. Also a USB connection was used as an example in the description, but the present invention can also be applied to other interfaces, such as ATAPI. The capacity of the cache memory and the number of segments are also not limited to those of the embodiments.

The host device was described using a personal computer, but the present invention can also be applied to a server and home electronic information equipment operated by an OS, such as a video recorder, TV and digital camera.

The present invention was described by the embodiments, but the present invention can be modified in various ways within the scope of the essential character of the present invention, which shall not be excluded from the scope of the present invention.

In this way, by notifying a segment change from the host device in advance before transfer of the write data and changing the number of segments of the cache memory according to the maximum transfer volume of one command which depends on the type of OS, the number of segments can be set to a desired number from the first stage of processing the write data by the medium storage device, so the write processing can be executed at high-speed with the number of segments appropriate for the write processing of that OS. Therefore the overhead of the medium storage device can be decreased, which contributes to increasing the speed of writing.

What is claimed is:

1. A medium storage device connected to a host device for storing write data from the host device, comprising:
a medium drive unit for recording data to a medium;
a cache memory for storing the write data from said host device; and
a controller for managing the number of segments of said cache memory and recording the write data stored in said cache memory into said medium drive unit,
wherein said controller sets the number of segments of said cache memory according to the type of OS of said host device notified from said host device in advance before the transfer of said write data.

2. The medium storage device according to claim 1, wherein said controller sets the number of segments of said cache memory according to the type of OS of said host device notified in the CDB format from said host device in advance before the transfer of said write data.

3. The medium storage device according to claim 1, wherein said controller sets the number of segments of said cache memory according to the type of OS of said host device and the type of format notified from said host device in advance before the transfer of said write data.

4. The medium storage device according to claim 1, wherein said controller comprises a table for storing the number of segments of said cache memory according to the type of OS of said host device sent from said host device, and sets the number of segments of said cache memory referring to said table.

5. The medium storage device according to claim 1, wherein said controller sets the number of segments of said cache memory according to the type of the OS of said host device that is set in a write command notified in the CDB format from said host device in advance before the transfer of said write data.

6. The medium storage device according to claim 1, wherein said controller sets the number of segments of said cache memory according to the type of the OS of said host device that is set in a vendor command notified in the CDB format from said host device in advance before the transfer of said write data.

7. The medium storage device according to claim 1, wherein said controller performs a write operation of said medium drive unit in the segment units of said cache memory.

8. The medium storage device according to claim 1, wherein said medium drive unit is structured by a drive mechanism for writing to said medium by a head.

9. A cache segment switching method for a medium storage device connected to a host device for storing write data from the host device, comprising the steps of:
setting the number of segments of a cache memory according to the type of OS of said host device notified from said host device in advance before the transfer of said write data;
storing the write data from said host device in the segment units of said cache memory that were set; and
recording the write data stored in said cache memory to the medium drive unit.

10. The cache segment switching method for a medium storage device according to claim 9,
wherein said setting step further comprises a step of setting the number of segments of said cache memory according to the type of the OS of said host device notified in CDB format from said host device in advance before the transfer of said write data.

11. The cache segment switching method for a medium storage device according to claim 9,
wherein said setting step further comprises a step of setting the number of segments of said cache memory according to the type of the OS of said host device and type of format notified from said host device in advance before the transfer of said write data.

12. The cache segment switching method for a medium storage device according to claim 9,
wherein said setting step further comprises a step of setting the number of segments of said cache memory referring to a table for storing the number of segments of said cache memory according to the type of the OS of said host device sent from said host device.

13. The cache segment switching method for a medium storage device according to claim 9,
wherein said setting step further comprises a step of setting the number of segments of said cache memory according to the type of the OS of said host device that is set in a predetermined command notified in the CDB format from said host device in advance before the transfer of said write data.

14. The cache segment switching method for a medium storage device according to claim 9,
wherein said recording step further comprises a step of causing a medium drive unit to execute a write operation in the segment units of said cache memory.

15. A media storage system comprising:
a host device for issuing a write command and write data; and
a medium storage device connected to said host device for storing the write data from said host device,
wherein said medium storage device comprises:
a medium drive unit for recording data to a medium;
a cache memory for storing the write data from said host device; and
a controller for managing the number of segments of said cache memory and recording the write data stored in said cache memory to said medium drive unit,
and wherein said host device notifies the type of the OS of said host device to said medium storage device by a driver in advance before the transfer of said write data, and said controller sets the number of segments of said cache memory according to the type of said OS.

16. The medium storage system according to claim 15, wherein said host device notifies the type of the OS of said host device to said medium storage device in the CDB format in advance before the transfer of said write data.

17. The medium storage system according to claim 15, wherein said host device notifies the type of the OS of said host device and the type of the format to said medium storage device in advance before the transfer of said write data,
and wherein said controller sets the number of segments of said cache memory according to said notified type of the OS and the type of the format.

18. The medium storage system according to claim 15, wherein said controller has a table for storing the number of segments of said cache memory according to the type of the OS of said host device sent from said host device, and sets the number of segments of said cache memory referring to said table.

19. The medium storage system according to claim 15, wherein said host device sets the type of the OS of said host device in a predetermined command in the CDB format in advance before the transfer of said write data.

20. The medium storage system according to claim 15, wherein said controller causes said medium drive unit to execute a write operation in the segment units of said cache memory.
